(19) United States
(12) Patent Application Publication
(10) Pub. No.: US 2012/0178072 A1
(43) Pub. Date: Jul. 12, 2012

(54) PSYCHOMETRIC TESTING METHOD AND SYSTEM

(76) Inventor: Gabriel Shmuel ADAM, Kiriat Bialik (IL)

(21) Appl. No.: 12/985,393

(22) Filed: Jan. 6, 2011

(51) Int. Cl. G09B 3/00

(52) U.S. Cl. 434/350

(57) ABSTRACT

A method of psychometric testing of a plurality of candidates for a position, the method comprising the steps of: specifying at least one psychometric test based upon a definition of the position, the psychometric test having a plurality of versions, each version having a corresponding plurality of items; registering each of the candidates; assembling a plurality of candidate tests corresponding to the plurality of candidates, each candidate test assembled from the plurality of versions, with each candidate test being substantially unique from other candidate tests; and administering the respective candidate tests to each of the candidates and to determine test results therefrom.

### FIELD AND BACKGROUND OF THE INVENTION

Embodiments of the current invention are related to psychometric testing of a candidate for a position. More specifically, embodiments of the present invention are directed to methods and systems of developing and administering psychometric examinations.

In the specification and claims which follow, the following terms are identified and defined:
“job position” or simply “position” are intended to mean a plurality of tasks and/or responsibilities of an individual, usually associated with a formalized role or name, within an organization and/or company. Frequently, a job position is defined or specified according to skills, knowledge, and responsibilities an individual will have or has. In reference to other situations, “position” is additionally intended to mean a plurality of personality traits and/or skills of an individual which qualify him join an organization or a course of studies.
“psychometric testing” is intended to mean a test and/or examination or a series of tests and/or examinations which are administered to an individual to learn more about his ability to fulfill a job position. For example, an employer could give psychometric testing to a candidate before the decision is made to offer the candidate a position with the employer. An additional meaning of the term “psychometric testing”, as used in the specification and claims hereinbelow, is that of “psychotechnical testing” and/or “vocational testing”.
“proctoring” is intended to mean the act of at least one individual being present during psychometric testing of a candidate for the expressed purpose of overseeing testing to ensure the candidate follows instructions such as, but not limited to: no interaction with others, identify himself fully, and not use other written material and/or any other devices.

Many organizations needing to evaluate new and current-employed workers take advantage of the benefits afforded from psychometric testing. Psychometric testing may be administered before or after a worker is hired and/or joins the organization. One field in which psychometric testing has proven especially advantageous is in pretesting candidates for a position—meaning before a position is filled. When a relatively large number of candidates apply for a given position, one method to relatively quickly review and screen candidates is to pretest them. An appropriate alternate expression to “pretest” is to obtain a “go/no go” indication—meaning an initial, quick, indication whether to consider the candidate further or not.

Psychometric testing has traditionally been done either in testing centers or at an employer location, for example, and the testing has traditionally been done in writing (i.e. with pen/pencil and paper). Improvements over manual/paper based methods include computer-based systems useful for storing tests, for candidate recruiting, and/or for evaluating new employees. Some of these systems allow pre-screening of candidates by administering various types and levels of tests, as known in the art. Examples of such prior art are noted hereinbelow.

US Patent Application Publication no. 20050240431 by Cotter, whose disclosure is incorporated herein by reference, describes a computerized method for screening job seekers and determining whether a job seeker is a qualified applicant for possible employment by an entity, the method delivered through the web. The method includes attracting a pool of job seekers to a web site; enabling each job seeker to choose at least one job of interest to the job seeker; pre-screening each job seeker for each job of interest to the job seeker by having each job seeker respond to a series of computerized questions which can be scored; determining if the job seeker is a qualified applicant in that the job seeker meets the requirements of the uniform federal employment guidelines which define a job applicant; and obtaining additional information over the computer from job seekers.

U.S. Pat. No. 6,996,367 by Pfenninger et al., whose disclosure is incorporated herein by reference, describes a test administration system, which includes a central computer and associated database containing a plurality of tests that may be distributed to a test taker. The central computer provides a website to be accessed by the test administrator and the test taker at remote personal computers when using the test administration system. The website includes an administrator workspace for use by the test administrator and a testing workspace for use by the test taker. The administrator workspace provides the test administrator with the ability to order any number of the tests contained in the database. After ordering a number of tests, the test administrator uses the system to generate test identification codes for a chosen set of ordered tests. The system automatically provides the test identification codes to those test subjects taking a test, and provides the test subject with access information and instructions for using the system to take the test. The test administrator workspace also provides the test administrator with valuable test status information concerning the tests ordered by the administrator.

Anderson, in U.S. Pat. No. 6,513,042 whose disclosure is incorporated herein by reference, describes a method of making a tests, assessments, surveys and lesson plans with images and sound files and posting them on-line for potential users. Questions are input by a test-maker and then the questions are compiled into a test by a host system and posted on-line for potential test-takers. The compiled test may be placed in a directory for access by the test-takers, the directory preferably having a plurality of categories corresponding to different types of tests and the compiled test is placed in the appropriate category. For ease in administration, a just-made test is placed into a temporary category so that it may be later reviewed (by the proprietor of the host system) and placed in the most appropriate category.

Criteria Corporation, 10780 Santa Monica Blvd, Los Angeles, Calif. 90025, has developed and markets a product called HireSelect®, which is a web-based system for administering pre-employment tests. Among the benefits claimed for HireSelect® are: determining which pre-employment tests to administer for each job position; scheduling and administering tests in minutes; viewing, storing, and sorting results, available immediately following test administration. Criteria Corp describes how a user can create and store his own tests and test batteries—although no details are given regarding a method of test creation, within the HireSelect® product or tests created by the user.

Other similar products are offered by:
HireLabs: 15023 SW Millikam Way #137, Beaverton, Oreg., 97006, USA; and by
Chequed.com Inc: 24 Hamilton Street, Suite 5A, Saratoga Springs, N.Y. 12866, USA; and by
eSkill Corporation, 141 Middlesex Road, Suite 12, Tyngsborough, Mass., 01879, USA.

US Patent Application Publication no. 20090233262 by Swanson, whose disclosure is incorporated herein by reference, describes a method and system for constructing a test using a computer system that performs specification matching during the test creation process is disclosed. A test developer determines one or more test item databases from which to select test items. The test item databases are organized based on psychometric and/or content specifications. The developer can examine the textual passages, artwork or statistical information pertaining to a test item before selecting it by clicking on a designation of the test item in a database. The developer can then add the test item to a list of test items for the test. The test development system updates pre-designated psychometric and content specification information as the developer adds each test item to the test. The test developer can use the specification information to determine whether to add to, subtract from, or modify the list of test items selected for the test.

Disadvantages for the prior art methods described above include:
Additional paperwork (in the case of paper-administered testing)
Specially-allocated testing rooms/centers/resources for paper testing as well as for computer-administered testing.
Overall reliability of results, in the case of remotely-administered testing, such as home-internet testing.
Additional manpower/expense for proctoring examinations to ensure higher test reliability.
No evaluation of the honesty of candidates (i.e.: Did the candidate himself take the exam?)

None of the prior art systems appear to offer solutions to all the problems listed above. Furthermore, because of the use of internet and remote-testing (for example, when the candidate takes the test in his home) and where there is no or little proctoring no proctoring, “copying”, poor test results reliability, and other problems resulting from the lack of proctoring are exacerbated. Candidates in this case may be tempted to receive help or even have another person take the exam in their place. In one worst-case scenario, a candidate may study and use a copy of a previously-given exam (available on-line or sent to him by an acquaintance, for example) which in most cases is the same exam given to the candidate for testing.

As a result, and because the same test may be given to more than one candidate, the value and reliability of test results is called into question. None of the prior art systems or methods addresses the central and vexing issue of providing unique tests to each candidate and thus augmenting test reliability.

There is therefore a need for a reliable way of psychometric testing of a candidate for a position, which can be administered easily and with little or no proctoring, while yielding high reliability of results—especially, inter alia, in determining and ensuring a given candidate is truly being tested.

### SUMMARY OF THE INVENTION

According to the teachings of the present invention there is provided a method of psychometric testing of a plurality of candidates for a position, the method comprising the steps of: specifying at least one psychometric test based upon a definition of the position, the psychometric test having a plurality of versions, each version having a corresponding plurality of items; registering each of the candidates; assembling a plurality of candidate tests corresponding to the plurality of candidates, each candidate test assembled from the plurality of versions, with each candidate test being substantially unique from other candidate tests; and administering the respective candidate tests to each of the candidates and to determine test results therefrom. Preferably, each of the versions has substantially similar validity power. Most preferably, substantially similar validity power is measured and ensured by analyses being applied to test results. Typically, assembling the candidate test further comprises the step of specifying a questions choosing mechanism. Most typically, the question choosing mechanism includes at least one algorithm chosen from the list containing: one-to-one choosing, random distribution, and beta distribution.

Preferably, the question choosing mechanism further includes a mechanism for changing the order of multiple choices of the question. Most preferably, the candidate test is administered remotely. Typically, administered remotely is at least one chosen from the list including notification by: email, internet, mail, video, and fax. Most typically, at least one psychometric test is administered without proctoring.

According to the teachings of the present invention there is further provided a system of psychometric testing of a plurality of candidates for a position, the system comprising: at least one psychometric test based upon a definition of the position, the psychometric test having a plurality of versions, each version having a corresponding plurality of items; a registration mechanism operatable for each of the candidates; a plurality of candidate tests being assembled and corresponding to the plurality of candidates, each candidate test being assembled from the plurality of versions, with each candidate test being substantially unique from other candidate tests; and respective candidate tests being administered to each of the candidates and test results being determined therefrom. Preferably, each of the versions has substantially similar validity power. Most preferably, analyses of test results are applicable to measure and ensure substantially similar validity power. Typically, a questions choosing mechanism is specifiable to assemble the candidate test.

According to the teachings of the present invention there is further provided a method of psychometric testing of a plurality of candidates for a position, the method comprising the steps of: specifying at least one psychometric test based upon a definition of the position, the psychometric test having a plurality of versions, each version having a corresponding plurality of items; registering each of the candidates; assembling a plurality of candidate tests corresponding to the plurality of candidates, each candidate test assembled from the plurality of versions, with each candidate test being substantially unique from other candidate tests; administering the respective candidate tests to a candidate in at least two settings, a first setting being unproctored and a second setting being proctored; and determining test results from the two settings and making an evaluation related to the honesty of the candidate.

### BRIEF DESCRIPTION OF THE DRAWINGS AND APPENDICES

The invention is herein described, by way of example only, with reference to the accompanying drawings, wherein:

FIG. 1 is a flowchart depicting a method of psychometric testing of a plurality of candidates for a position, in accordance with embodiments of the current invention;

FIG. 2 is a flowchart detailing the steps assemble candidate test and administer candidate test of FIG. 1, in accordance with an embodiment of the current invention;

FIG. 3 is a block diagram illustrating elements in assembling a candidate test, in accordance with embodiments of the current invention; and

FIGS. 4 to 6 are pictorial screens of user interfaces related to the steps of the flowcharts of FIGS. 1 and 2, in accordance with an embodiment of the current invention.

### DETAILED DESCRIPTION OF THE PREFERRED EMBODIMENTS

The current invention relates to psychometric testing of a candidate for a position. More specifically, embodiments of the present invention are directed to methods and systems of developing and administering psychometric examinations.

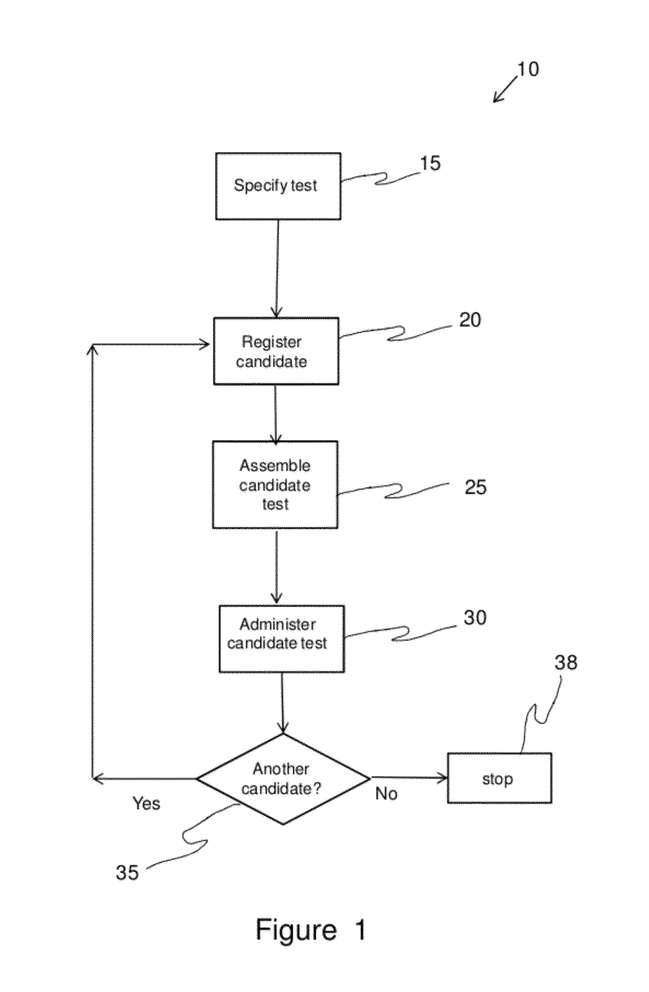

Reference is currently made to FIG. 1, which is flowchart showing a method of psychometric testing 10, of a plurality of candidates for a position, in accordance with embodiments of the current invention. In specify test 15, the psychometric test to be administered for a given position is specified, according to previously-made definition by the test developer/test preparer. In some cases, the psychometric test to be administered is composed of one or more specific tests of skill, ability, and/or aptitude, as known in the art. By way of example only, if a position is “senior programmer”, then exemplary tests defined are; mathematical aptitude and language skills. The term “psychometric test”, as used in the specification and claims which follow is intended to mean one or more specific tests as noted and described hereinabove. Furthermore, while “psychometric test” is described hereinbelow as one specific test (i.e. in the singular), the term is likewise applicable to and can include two or more specific tests, mutatis mutandis. The psychometric test specified for a given position is typically prepared and identified in advance, in an off-line framework, by a test preparer. In the current step, respective psychometric tests are specified for specific positions, each position having its own psychometric test. An additional discussion related to psychometric test specification and preparation is presented hereinbelow. Unless indicated otherwise, the term “test” used hereinbelow refers to a psychometric test.

The following step, register candidate 20, is repeated for each candidate, and includes specific candidate information being registered/recorded. Register candidate 20 may include, inter alia, recording: candidate name/address information; candidate educational/experience background; position desired; email address; telephone number; and other test-scheduling and/or logistics related information. A typical registration mechanism is by direct computer input, although paper input and/or other media useable by a computer is possible.

Registered information is typically received and reviewed off-line by a test administrator or other person having similar responsibility in the organization giving the test—although alternatively or optionally, reviewing the information may be done in near-real time and/or with some automation. The position identified by the candidate is verified and/or changed, as part of the review. Following the review, once the position is finalized/determined, the appropriate psychometric test is identified, as specified (obtained from step 15). Then, assemble candidate test 25, and administer candidate test 30 take place. “Candidate test” as used in the specification and claims which follow is intended to mean the specific psychometric test that is prepared for and administered to a candidate. “Candidate test” and steps 25 and 30 are described further in detail hereinbelow.

Following administer candidate test 30, a check is performed in step 35, another candidate? If there is an additional candidate (YES) then control is reverted to step 15, specify test, and the procedure repeats itself. If there is no additional candidate, then control proceeds to step 38, stop. When and if there are additional candidates, the method is reinitiated at step 20. When and if there are additional positions and respective psychometric tests, the method is reinitiated at step 15.

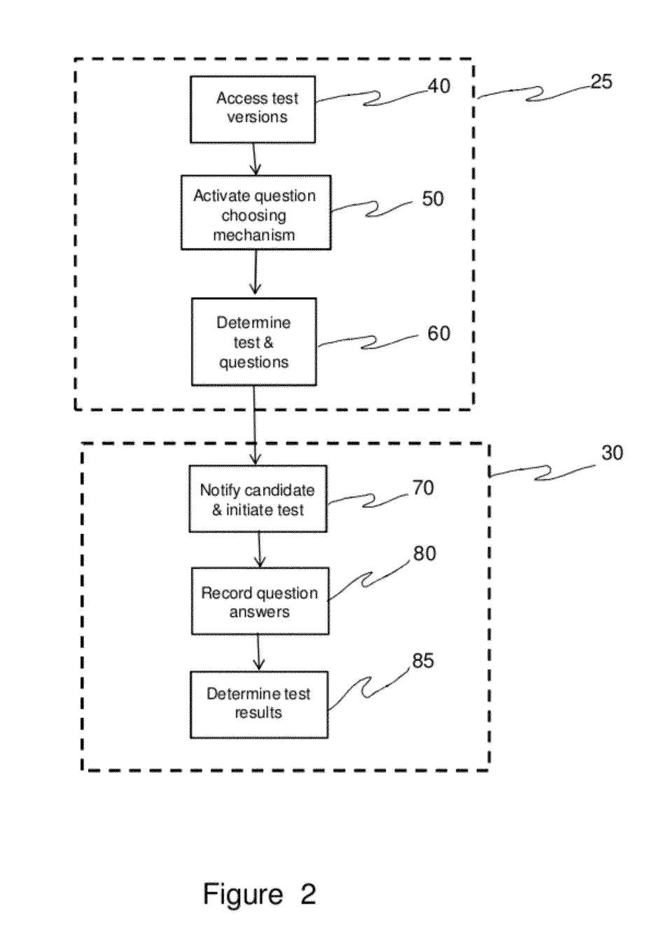

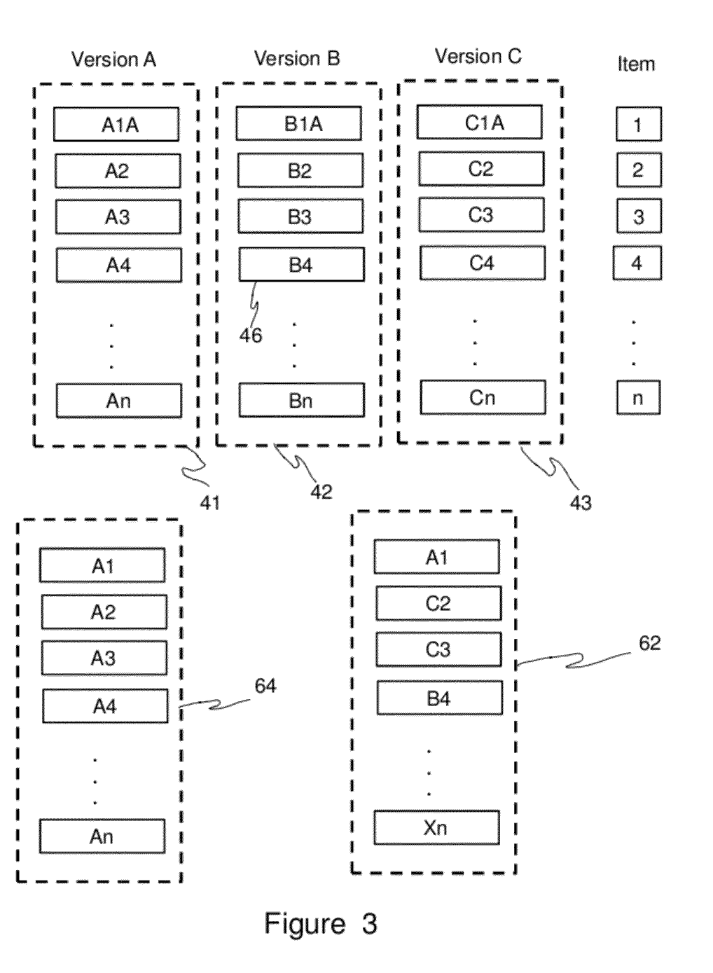

Reference is presently made to FIGS. 2 and 3, which is a flowchart detailing the steps assemble candidate test 25 and administer candidate test 30 of FIG. 1, and a block diagram showing elements used in assembling a candidate test, respectively, in accordance with embodiments of the current invention. Apart from differences described below, assemble candidate test 25 and administer candidate test 30 are identical in notation, configuration, and functionality to that shown in FIG. 1, and elements indicated by the same reference numerals and/or letters are generally identical in configuration, operation, and functionality as described hereinabove.

The first step is access test versions 40, in FIG. 2. Recall, in FIG. 1, that a psychometric test for a given position was specified in step 15. “Test version”, as used in the specification and claims which follows is intended to mean a version of the specified psychometric test. Typically more than one test version is developed in advance by a test preparer, such as a psychometrician, inter alia, for the psychometric test, as further described hereinbelow.

In FIG. 3, test versions 41, 42, and 43, respectively denoted as Version A, Version B, and Version C are versions of a psychometric test. A psychometric test in embodiments of the current invention may include more than three versions shown in the figure. Each test version has corresponding questions 46, and each test version has an identical and corresponding number of questions running from 1 to n. The respective questions are identified within each version (ex: A1, A2, and B1, B2, etc.). The subject content and relative ordinate of a question within a version is referred to hereinbelow as an “item” (indicated as 1, 2, 3, . . . n, as denoted in the figure). Test versions are configured so that each item of the test set has the same subject content and difficulty level associated it with it.

To ensure the same subject content and difficulty level of each item, the test developer, before writing the specific question—and as part of the psychometric test specification—specifies the content of each question in the psychometric test. Typically, difficulty level is monotonically increased in successive questions of psychometric tests, however this is not mandatory. Item difficulty level is determined at a later stage using an item difficulty index, which is calculated as the percentage of candidates correctly answering an item in each test version separately. Candidate testing, to allow determination of the item difficulty index, is performed in advance and/or over time. The procedure of specification-testing-item difficulty determination is typically performed much more than once, allowing for changes and improvement in questions and test versions.

As shown in the figure, questions A3, B3, and C3 are all identified as item 3. All three questions, while different from one another, have the same subject content and difficulty level as described hereinabove.

The next step in FIG. 2 is activate question choosing mechanism 50. Question choosing mechanism is alternatively referred to hereinbelow as “question choosing algorithm” and both expressions are used hereinbelow interchangeably. Because the test set has a number of questions associated with each item, a mechanism is chosen to enable the following step, determine test and questions 60, to be performed.

One objective of the question choosing mechanism, as described further hereinbelow, is to ensure each resultant candidate test is “unique”, as compared to other candidate tests for the same position. The expressions “unique” and “uniqueness”, when applied to individual candidate tests, as used in the specification and in the claims which follow, is intended to mean that no two candidate tests, derived from the respective psychometric test, are duplicates of one another. The expression “non-duplicate” is used hereinbelow interchangeably with “unique” and “uniqueness” in this context.

To better describe steps 50 and 60, reference is made to two candidate tests 62 and 64, as shown in FIG. 3. In candidate test 62, it can be seen that the first question (from item 1) is A1, the second question (from item 2) is C2, the third question (from item 3) is C3, etc. Alternatively, in candidate test 64, the questions are ordered A1, A2, A3, etc. The mechanism chosen to assemble questions for candidate test 64 could be called “one-to-one questions from a chosen version” (in this example, the chosen version is version A). The “one-to-one” mechanism is relatively simple/trivial in that it yields a finite number of non-duplicate candidate tests, equivalent to the number of versions. Using this mechanism, the only way to create a relatively large number of unique candidate tests is to create a correspondingly large number of versions, which represents a significant and undesirable effort.

A more interesting type of question choosing mechanism is applied to generate candidate test 62. In candidate test 62, the questions are certainly not the result of a “one-to-one” mechanism, as can be seen from the order of A1, C2, C3, and B4. In fact, an embodiment of the current invention utilizes a “random choosing” mechanism, using a randomizing algorithm, as known in the art, to choose from respective items across versions to specify respective questions for the candidate test. Alternatively or optionally, other mechanisms as known in the art, not based necessarily on a randomizing algorithm but based on any other distribution function (i.e. beta distribution or other distributions, for example) may be employed to choose from respective items across versions to specify respective questions for the candidate test. One objective of the choosing mechanism is to generate a relatively large number of unique candidate tests while not having to create a large number of versions. Typically, the number of versions ranges from 3 to 9, although the number of versions may be larger, especially in an initial trial-version development phase. Additional discussion of considerations related to the question choosing algorithm is presented hereinbelow.

Once the mechanism to assemble questions is chosen, control proceeds to step 60. The mechanism (or “algorithm”) is applied for every item to yield respective questions for the candidate test.

As part of step 60, an additional operation is alternatively or optionally included. In most multiple-choice questions (the form of questions most commonly used in psychometric tests) there are typically 3, 4, or 5 choices presented. For each question chosen for the candidate test, the order of the multiple choices presented in the question is randomized. This additional randomizing feature means that even when, for example, question C3 appears in more than one candidate test, the order of the multiple choices of the question can be different from one candidate test to another. Randomization of the order of the multiple choices further enhances overall uniqueness of the candidate test, because even if the same question (for example C3) is used in different candidate tests, the respective orders of the choices in the questions are different.

Control presently proceeds to administer candidate test 30. The first step in administer candidate test 30 is notify candidate and initiate test 70. The candidate may be alerted in real time, if he remains on-line following the previous steps, or he may be more typically alerted off-line, such as by email, telephone, text message, fax, etc. A typical way to alert the candidate is by email and/ or a screen-displayed URL link. The link leads the candidate to the appropriate internet location, as known in the art, where the candidate test (as assembled in the previous steps) may be found and where the candidate may begin the test. Additional description regarding the current step is provided hereinbelow. The test is initiated essentially by the candidate himself, although the method can include initiation of the test for the candidate, either remotely or in close proximity to the candidate.

As the candidate completes the candidate test, his answers are recorded in record question answers, step 80. The next step, determine test results 85, may include not only identification of correct and incorrect answers and determination of a test score, but any additional statistical calculations and/or analyses of the candidate test including, but not limited to: comparison/analysis of the current candidate test results versus those of similar candidate tests, and; analyses of score results of items of the current candidate versus items score results of similar candidate tests. Comparisons and analyses such as those noted hereinabove are useful not only in evaluating the current candidate versus others, but also in evaluating and checking aspects of the current candidate test versus those of other candidate tests, as noted above and further described hereinbelow.

As previously noted, an important feature of one embodiment of the current invention is the uniqueness or non-duplication of each test and/or test battery prepared for the candidate (i.e. “candidate test”). The question choosing algorithm, as mentioned hereinabove, contributes to ensuring uniqueness. Additionally, the mechanism of mixing the order of multiple choices described hereinabove further contributes to uniqueness. Although the manner of assembling the candidate exam described hereinabove has many advantages, a number of challenges arise for the test developer (i.e., the “psychometrician”). One challenge is how to calculate test consistency, when each candidate receives a unique or non-duplicate candidate test. Candidate test consistency is a most important feature of a psychometric test given across a population of candidates taking such a test for the same position. Test consistency (also referred to hereinbelow as test equivalence) is a measure of whether candidates score similar results for the psychometric test each time the test is administered, regardless variables, such as, but not limited to: the time the test is given; and the number of candidate tests generated/assembled.

Another challenge is whether all versions possess the same validity power. The term “validity power”, as used in the specification and claims hereinbelow, is intended to mean the measure of success as to what extent satisfactory candidates are identified, as specified by the employer for the defined position. For example, in the specific case of pre-employment screening, the objective is to identify or select candidates that will satisfactory fill the defined position.

One way to deal with considerations of validity power, consistency, and uniqueness is to perform the following procedure:

1. As noted hereinabove, before creating test versions and individual test questions, a test specification for the position is generated. All versions of a respective question follow the test specification, as to ensure content equivalence. For example, if a specific item in a verbal math problem involves a question associated with a percentile problem; then all the questions for the same item across test versions will involve a percentile problem question. Once initial test versions having respective items are generated, candidate tests are subsequently generated as described hereinabove and statistical analyses are applied to measure and determine respective items across test versions, while not duplicating content, are similar in difficulty. In other words, statistical analyses are applied to measure and to ensure similar validity power.

2. After collecting statistical data, a chi-square analysis is used (as described below) to test for a correlation between the versions of an item (A, B, C—as in FIG. 3) and the grades for the test question/item (0 for wrong answer, 1 for correct answer). There should be no significant correlation between the version of an item and the grade obtained for respective questions (i.e. standard deviation>0.05).

### Test Consistency Determination Using Chi-Square Analysis

To perform the chi-square analysis mentioned above, the following steps are performed:
a. Data collection stage. At least 100 candidates are tested to allow meaningful analysis to be performed.
b. Use the data collected, create a table, such as the exemplary “observed table” below, summarizing the number of candidates for each version having right answers and wrong answers for respective items.

A sample calculation procedure, based on the data presented, is further described.

Observed Table

| | right | wrong | Totals |
|---|---|---|---|
| Version A | 25 | 10 | 35 |
| Version B | 22 | 12 | 34 |
| Version C | 27 | 13 | 40 |
| Totals | 74 | 35 | 109 total |
| | | | candidates |

c. Take the data of the “observed table” and enter calculated expected value data in the table below (in parentheses) with the assumption that there is no correlation between versions and the successfully answered questions. Expected values are calculated by using the value of a cell, multiplying it by its row total and dividing by the total candidates. For example, the expected value of the cell described by Version A, “right” is (25×35)/109=23.76.

Observed + Expected value table

| | right | wrong | Totals |
|---|---|---|---|
| Version 1 | 25 (23.76) | 10 (11.24) | 35 |
| Version 2 | 22 (23.08) | 12 (10.92) | 34 |
| Version 3 | 27 (27.16) | 13 (12.84) | 40 |
| TOTALS | 74 | 35 | Total candidates: |
| | | | 109 |

d. Calculate the CHI-SQUARE according to the following formula:

X²=Σ[(o−e)²/e], where: “o” is the observed value and “e” is the expected value.

A small X² value is evidenced for a small difference between observed values and the expected values under “no connection between version and success” assumption. The following calculations demonstrate this point.

$${x}^{2} = \frac{{( 25 - 23.76 )}^{2}}{23.76} + \frac{{( 10 - 11.24 )}^{2}}{11.24} + \frac{{( 22 - 23.08 )}^{2}}{23.08} + \frac{{( 12 - 10.92 )}^{2}}{10.92} + \frac{{( 27 - 27.16 )}^{2}}{27.16} - \frac{{( 13 - 12.84 )}^{2}}{12.84}$$

$${x}^{2} = \frac{{( 1.24 )}^{2}}{23.76} + \frac{{( - 1.24 )}^{2}}{11.24} + \frac{{( - 1.08 )}^{2}}{23.08} + \frac{{( 1.08 )}^{2}}{10.92} + \frac{{( - 0.16 )}^{2}}{27.16} + \frac{{( 0.16 )}^{2}}{12.84}$$

$${x}^{2} = \frac{1.54}{23.76} + \frac{1.54}{11.24} + \frac{1.17}{23.08} + \frac{1.17}{10.92} + \frac{0.03}{27.16} + \frac{0.03}{12.84}$$

$${x}^{2} = 0.07 + 0.14 + 0.05 + 0.11 + 0.001 + 0.02$$

$${x}^{2} = 0.37$$

e. Check if X² is significant using the CHI-SQUARE table, using df (degrees of freedom)=[(number of versions−1)*(number of score potions−1)], and alpha (probability value)=0.05.
   If X² is smaller than the value in the table—there is no significant correlation between the version and success, meaning all version are substantially equivalent, and the version may be randomly replaced with one another.
   In the exemplary case hereinabove, the critical X² value, as shown in the table is 5.99. We have received a much smaller value (0.37), meaning that there is no correlation between version and answer (X²₍₂₎=0.37, n.s., N=100)
      The procedure above is repeated for all test items.

The method and system described hereinabove may also be applied to evaluate/give an indication of the candidate's honesty/integrity. One way to do this is to test in two settings. In other words, initially test the candidate without proctoring (for example, at his home, by himself) and then administer an additional candidate test with proctoring. Because it has been shown above that the different test versions are substantially unique AND consistent, results from the unproctored exam versus the proctored exam for the same candidate should be relatively similar—whereas two different candidates (such as the candidate's friend taking the first unproctored test, and the candidate himself taking the second proctored test) would yield relatively different results.

More specifically, after calculating test reliability (as described hereinbelow), the data can be used to make an evaluation related to the candidate honesty/integrity.

Identifying test reliability as X (and further defined hereinbelow), use SE_{diff} to determine which range of grades is a random difference, versus a difference reflecting different abilities between two tests. Naturally, one candidate taking the test twice shouldn't have grades indicating any different abilities. A result yielding different abilities would suggest two different people, meaning there was dishonesty.

SE_{diff}=Z*Sd*\sqrt{2 2r₁₁}.

Z=1.65 for 90% confidence; 1.96 for 95%; and 2.58 for 99% confidence r₁₁ is the reliability coefficient, and Sd is the standard deviation of the test results. Sd is calculated by the standard deviation formula, as known in the art, (where s_{N} is an alternative indication, equivalent to Sd):

$${s}_{N} = \sqrt{\frac{1}{N} {\sum }_{i = 1}^{N} {( {x}_{i} - \overline{x} )}^{2} .}$$

The SE_{diff} resultant value should be compared to the difference between the two test results of the candidate. The obtained difference value is called “calculated difference”. If the SE_{diff} is greater than the calculated difference, then the candidate is honest in his test taking (in 90% confidences, for example). If SE_{diff} is smaller than the calculated difference, then there is 90% confidence (for example) that the same person did not take the test in both instances.

In addition to the overall methods of calculation described hereinabove; an additional aspect of enhancing a candidate's honesty becomes apparent. Before the candidate is administered the test, the test administrator may advise the candidate (by telephone or by email message, for example) that the psychometric test he will be taking has features that can make a determination of candidate honesty, specifically related to the same person taking the present and follow-up tests. The instruction/warning can prove useful in of itself in most cases!

Along with the concept of making a determination of candidate honesty described hereinabove, the question choosing mechanism described previously in FIGS. 2 and 3 can be chosen and/or operated in various ways to generate the two unique candidate tests to be administered to'the candidate for the two settings. For example (referring to FIG. 3 and the three test Versions: A; B; and C) the first setting candidate test may be simply Version A and the second setting candidate test may be simply Version B. In this example, the “one-to-one” generator is operated. Another option would be to use a random generator for candidate test for both settings, respectively. Another possibility would be to use a one-to-generator for one setting and a random generator for another. Finally, other combinations and permutations, such as: one-to-one for the first 50% of the questions of Version A and then one-to-one for the second 50% of questions of Version B; one-to-one on different percentages of versions; and other combinations of generators. Overall, the underlying concept is to administer two totally different candidate tests for the two respective settings.

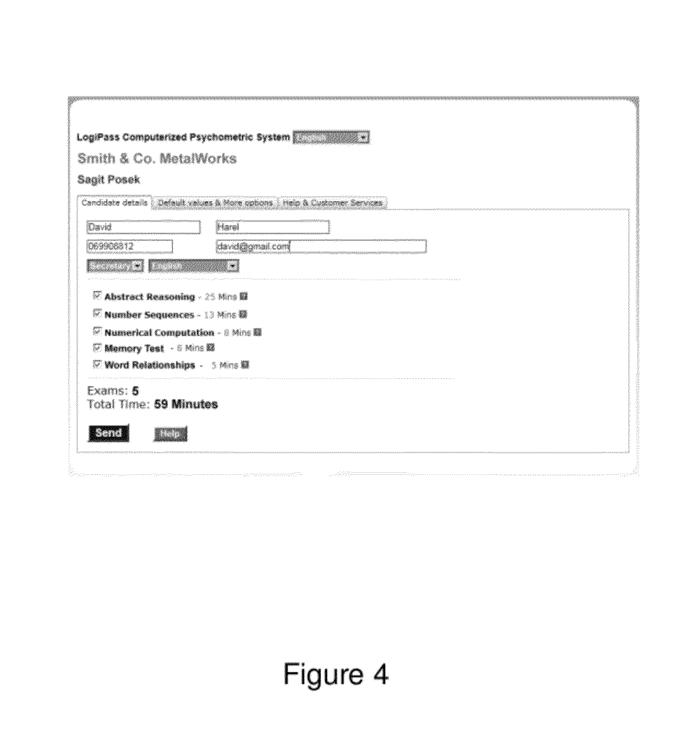

Reference is presently made to FIGS. 4 to 6, which are exemplary pictorial screens related to the steps in FIGS. 1 and 2, in accordance with an embodiment of the current invention. Specifically, FIG. 4 is an exemplary pictorial screen showing information entered by the test administrator/psychometrician, following step 15 of FIG. 1. Among the information indicated in the figure are the individual psychometric tests specified for the candidate.

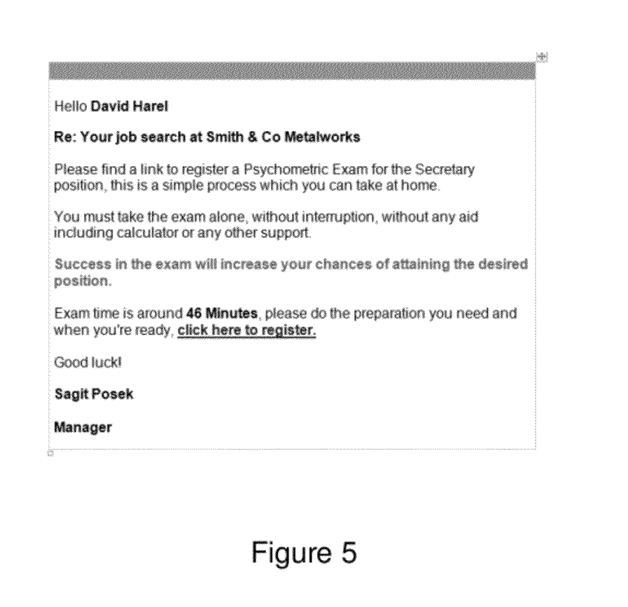

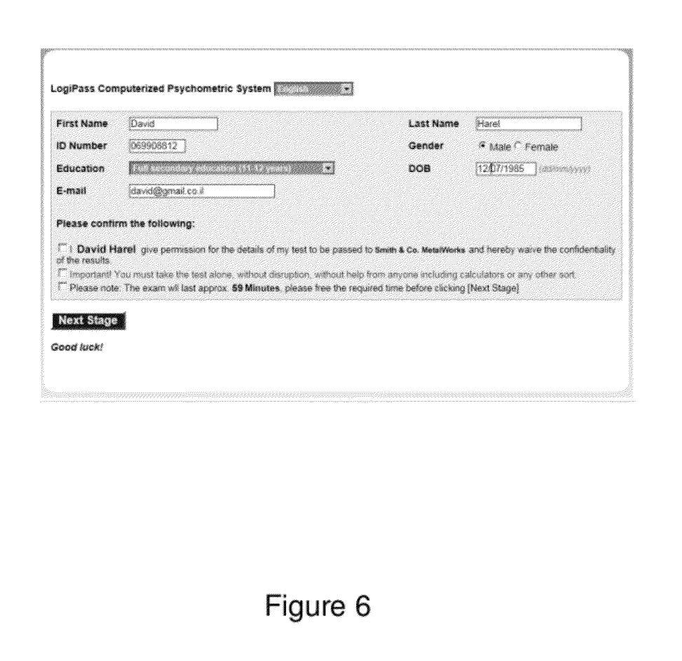

FIG. 5 is an exemplary pictorial screen presented to the candidate, as part of step 20 of FIG. 1. The screen shown in the current figure may be visible to the candidate immediately following the screen shown in FIG. 4. Alternatively or optionally, the screen shown in the current figure could be part of an email notification, following an off-line process performed by the test administrator. The link shown in the figure “click to register” represents the last part of “register candidate” in FIG. 1, leading to FIG. 6.

FIG. 6 is an exemplary pictorial screen presented to the candidate in the last part of step 20 of FIG. 1. Among exemplary values shown in the screed are: candidate name (David Harel); ID number and email; position (Secretary) and language (English). Also seen in the figure a checkbox for the candidate to allow details of the test to be passed to the organization (example: Smith & Co.) as well as the candidate's confirmation to move to the next steps, namely steps 25 and 30 in FIG. 1.

It will be appreciated that the above descriptions are intended only to serve as examples, and that many other embodiments are possible within the scope of the present invention as defined in the appended claims.

1. A method of psychometric testing of a plurality of candidates for a position, the method comprising the steps of:
specifying at least one psychometric test based upon a definition of the position, the psychometric test having a plurality of versions, each version having a corresponding plurality of items;
registering each of the candidates;
assembling a plurality of candidate tests corresponding to the plurality of candidates, each candidate test assembled from the plurality of versions, with each candidate test being substantially unique from other candidate tests; and
administering the respective candidate tests to each of the candidates and to determine test results therefrom.

2. The method of claim 1, whereby each of the versions has substantially similar validity power.

3. The method of claim 2, whereby substantially similar validity power is measured and ensured by analyses being applied to test results.

4. The method of claim 3, whereby assembling the candidate test further comprises the step of specifying a questions choosing mechanism.

5. The method of claim 4, whereby the question choosing mechanism includes at least one algorithm chosen from the list containing: one-to-one choosing, random distribution, and beta distribution.

6. The method of claim 5, whereby the question choosing mechanism further includes a mechanism for changing the order of multiple choices of the question.

7. The method of claim 1, whereby the candidate test is administered remotely.

8. The method of claim 7, whereby administered remotely is at least one chosen from the list including notification by: email, internet, mail, video, and fax.

9. The method of claim 1, whereby the at least one psychometric test is administered without proctoring.

10. A system of psychometric testing of a plurality of candidates for a position, the system comprising:
at least one psychometric test based upon a definition of the position, the psychometric test having a plurality of versions, each version having a corresponding plurality of items;
a registration mechanism operatable for each of the candidates;
a plurality of candidate tests being assembled and corresponding to the plurality of candidates, each candidate test being assembled from the plurality of versions, with each candidate test being substantially unique from other candidate tests; and
respective candidate tests being administered to each of the candidates and test results being determined therefrom.

11. The system of claim 10, wherein each of the versions has substantially similar validity power.

12. The system of claim 11, wherein analyses of test results are applicable to measure and ensure substantially similar validity power.

13. The system of claim 12, wherein a questions choosing mechanism is specifiable to assemble the candidate test.

14. A method of psychometric testing of a plurality of candidates for a position, the method comprising the steps of:
specifying at least one psychometric test based upon a definition of the position, the psychometric test having a plurality of versions, each version having a corresponding plurality of items;
registering each of the candidates;
assembling a plurality of candidate tests corresponding to the plurality of candidates, each candidate test assembled from the plurality of versions, with each candidate test being substantially unique from other candidate tests;
administering the respective candidate tests to a candidate in at least two settings, a first setting being unproctored and a second setting being proctored; and
determining test results from the two settings and making an evaluation related to the honesty of the candidate.
